(19) United States
(12) Patent Application Publication
(10) Pub. No.: US 2008/0296333 A1
(43) Pub. Date: Dec. 4, 2008

(54) Mounting structure

(76) Inventor: Paul Brassard, Arcadia, CA (US)

Correspondence Address: JAMES E. BRUNTON, ESQ., P. O. BOX 29000, GLENDALE, CA, 91209, US

(21) Appl. No.: 12/154,564

(22) Filed: May 23, 2008

Related U.S. Application Data
(63) Continuation-in-part of application No. 11/216,309, filed on Aug. 30, 2005, now abandoned.

(51) Int. Cl. B60R 11/00

(52) U.S. Cl. 224/555

(57) ABSTRACT

An improved mounting structure for mounting objects, such as handheld electronic devices, within a vehicle. The improved mounting structure includes a novel mounting plate that is provided with a pair of spaced-apart, uniquely-shaped connector elements that can be securely mated with connector elements provided on an object connector plate to which the handheld electronic device is connected.

This is a Continuation-In-Part Application of co-pending Application U.S. Ser. No. 11/216,309 filed Aug. 30, 2005.

### BACKGROUND OF THE INVENTION

### Field of the Invention

The present invention relates generally to mounting structures for supporting articles especially within vehicles. More particularly, the invention concerns an improved mounting structure for mounting electronic devices which comprises a mounting plate having a pair of uniquely configured, spaced-apart connector elements that are designed to be used in interconnecting a selected object connector plate with the improved mounting structure.

### SUMMARY OF THE INVENTION

It is an object of the present invention to provide an improved mounting structure for mounting objects, such as PDAs, palm devices, and like electronic components within a vehicle. More particularly it is an object of the invention to provide such a mounting structure which includes a uniquely designed mounting plate that can be used in interconnecting an object connector plate with the improved mounting structure.

Another object of the invention is to provide an improved mounting structure of the aforementioned character in which the mounting plate is provided with a pair of spaced-apart, uniquely-shaped connector elements that can be securely mated with connector elements provided on the object connector plate.

Another object of the invention is to provide an improved mounting structure of the character described in the preceding paragraphs in which the improved mounting plate provides a more secure fit with the object connector plate than was possible with prior art constructions.

Another object of the invention is to provide an improved mounting structure of the class described in which the improved mounting plate provides a reliable, robust interconnection between the mounting plate and the object connector plate to which the object to be mounted is secured.

Another object of the invention is to provide an improved mounting structure of the character described in which the improved mounting plate is provided with uniquely designed connector elements that snugly receive connector elements on the object connector plate so that play between the object connector plate and the improved mounting structure is minimized.

Another object of the invention is to provide an improved mounting structure which includes novel release means for releasing the suction on the suction-type connector of the mounting structure.

Another object of the invention is to provide an improved mounting structure as described in the preceding paragraphs which is compact, easy to use and is economical to manufacture in large quantities.

### BRIEF DESCRIPTION OF THE DRAWINGS

FIG. 1 is a generally perspective top view of one form of the improved mounting structure of the present invention.

FIG. 1A is a generally perspective view of a prior art mounting structure, several features of which have been modified and improved in the improved mounting structure of the present invention.

FIG. 2 is a generally perspective bottom view of the improved mounting structure shown in FIG. 1.

FIG. 3 is a generally perspective, exploded view of the improved mounting structure shown in FIGS. 1 and 2 of the drawings.

FIG. 4 is a longitudinal, cross-sectional view of the improved mounting structure shown in FIGS. 1 and 2.

FIG. 4A is a generally perspective, exploded view of one form of the mounting plate and object connector plate of the invention, the mounting plate being partly broken away to showing internal construction.

FIG. 4B is an exploded, side-elevational view of the mounting plate and object connector plate shown in FIG. 4A, the object connector plate being partially broken away to show internal construction.

FIG. 4C is a generally perspective view of the mounting plate and object connector plate shown in FIG. 4A, as the components appear when in the position to be moved into an interlocking configuration.

FIG. 4D is a cross-sectional view taken along lines 4D-4D of FIG. 4C.

FIG. 4E is a generally perspective, diagrammatic view, similar to FIG. 4C illustrating movement of the mounting plate and connector plate into an interlocking configuration.

FIG. 4F is a cross-sectional view taken along lines 4F-4F of FIG. 4E showing the mounting plate and connector plate in an interconnected configuration.

FIG. 5 is a generally perspective top view, similar to that shown in FIG. 1, but showing one form of the object connector plate interconnected with the mounting plate.

FIG. 6 is a generally perspective top view, similar to that shown in FIG. 1, but showing an alternate form of the object connector plate of the invention interconnected with the mounting plate of the improved mounting structure.

FIG. 7 is a generally perspective top view of an alternate form of the improved mounting structure of the present invention.

FIG. 7A is a generally perspective, exploded view of the mounting plate shown in FIG. 7 along with an object connector plate of the invention, the mounting plate being partly broken away to showing internal construction.

FIG. 7B is a generally perspective, exploded view, similar to FIG. 7A, but showing the mounting plate inverted and ready for interconnection with the object connector plate of the invention.

FIG. 7C is an exploded, side-elevational view of the mounting plate and object connector plate shown in FIG. 7A, the object connector plate being partially broken away to show internal construction.

FIG. 7D is a generally perspective view of the mounting plate and object connector plate shown in FIG. 7C as the components appear when in the position to be moved into an interlocking configuration.

FIG. 7E is a generally perspective, diagrammatic view, similar to FIG. 7C, but showing the mounting plate and inverted connector plate in an interconnected configuration.

FIG. 8 is a generally perspective front view of still another alternate form of the improved mounting structure of the present invention.

FIG. 9 is a generally perspective view of the alternate form of connector plate used in connection with the apparatus of the invention illustrated in FIG. 8.

FIG. 10 is a top plan view of the alternate form of connector plate shown in FIG. 9.

FIG. 11 is a generally perspective rear view of the form of the improved mounting structure of invention shown in FIG. 8.

FIG. 12 is a left side view of the improved mounting structure shown in FIG. 11.

FIG. 13 is a right side view of the improved mounting structure shown in FIG. 11.

FIG. 14 is a top plan view of the improved mounting structure shown in FIG. 11.

FIG. 15 is a view taken along lines 15-15 of FIG. 14.

FIG. 16 is a cross-sectional view taken along lines 16-16 of FIG. 15.

FIG. 17 is a cross-sectional view taken along lines 17-17 of FIG. 15.

FIG. 18 is a generally perspective, exploded view of the alternate form of the improved mounting structure shown in FIG. 8.

FIG. 19 is an exploded, side-elevational view of the mounting plate and object connector plate of this latest form of the invention, the object connector plate being partially broken away to show internal construction.

FIG. 19A is a side-elevational view of the mounting plate and object connector plate shown in FIG. 19 as the components appear when in position to be moved into an interlocking configuration.

FIG. 19B is a side-elevational, diagrammatic view, similar to FIG. 19A illustrating the mounting plate and connector plate in an interlocked configuration.

FIG. 20 is a generally perspective top view of an alternate form of the improved mounting structure of the present invention.

FIG. 21 is a top view of the improved mounting structure shown in FIG. 20.

FIG. 22 is a greatly enlarged view of the area designated in FIG. 21 as “22”.

FIG. 23 is a longitudinal, cross-sectional view of the improved mounting structure shown in FIGS. 21 and 22.

### DESCRIPTION OF THE INVENTION

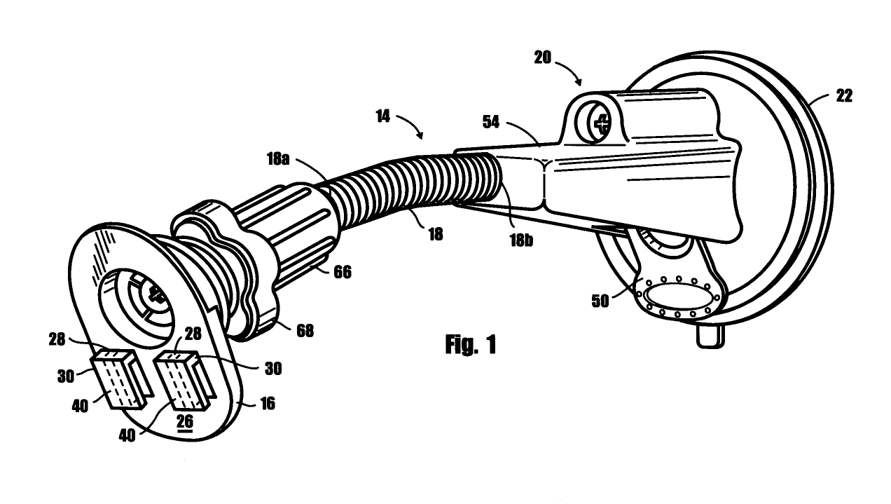

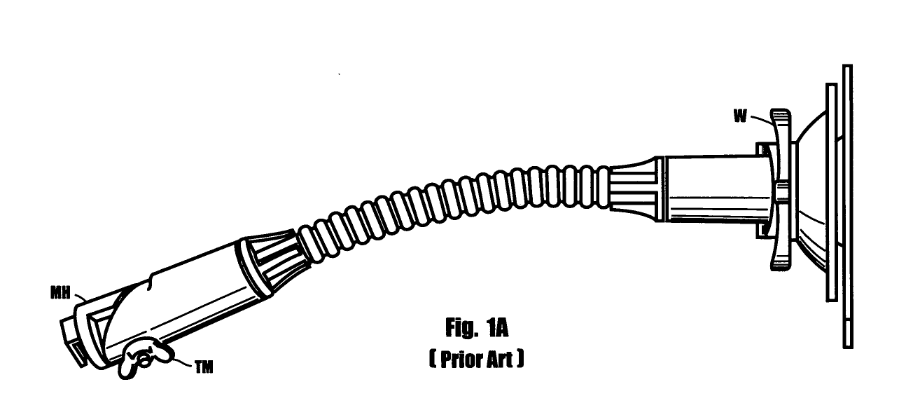

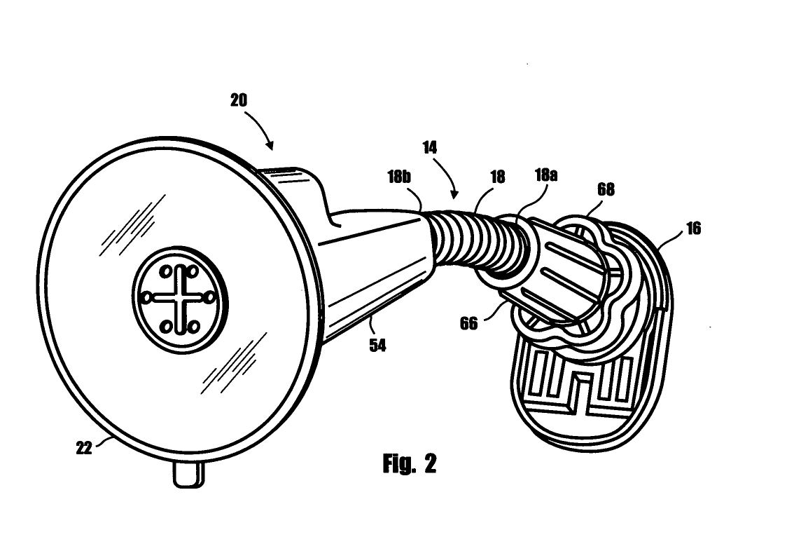

Referring to the drawings and particularly to FIGS. 1, 2 and 3, one form of the improved mounting structure of the present invention for use with a selected object connector plate is there illustrated and generally designated by the number 14. One of the improvements of the improved mounting structure over prior art devices, such as that illustrated in FIG. 1A of the drawings, resides in construction of the improved mounting plate 16 of the structure to which a selected object connector plate is interconnected to form the object mounting structure of the invention. The details of construction of this improved mounting structure will presently be described.

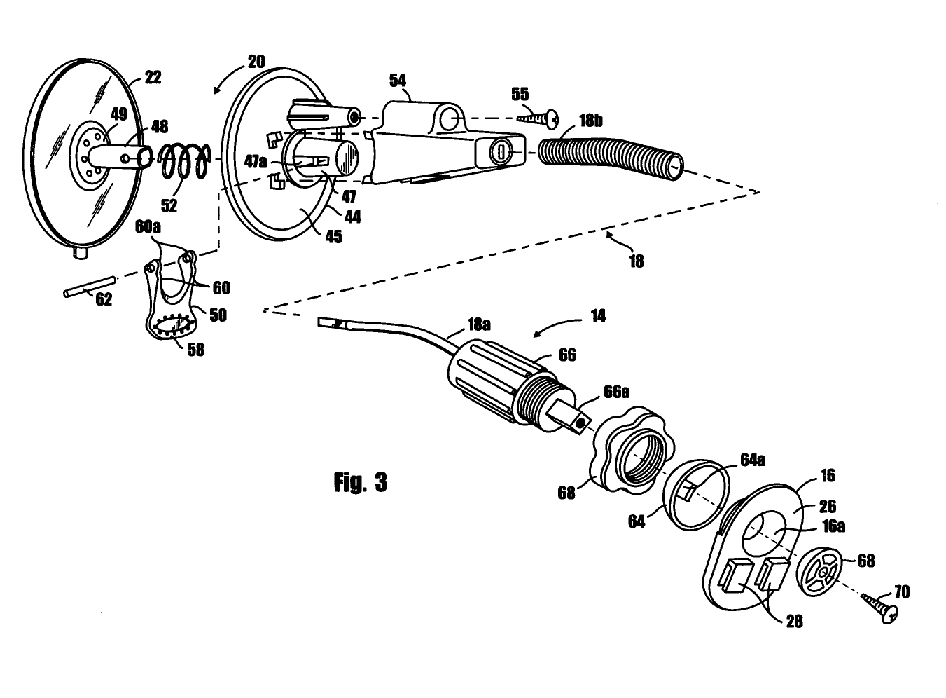

As shown in FIG. 1, the improved mounting plate 16 is interconnected with the first end 18a of an elongated flexible arm 18 by connector means, the details of construction of which are best seen in FIG. 3 of the drawings. Connected at the opposite, or second, end 18b of flexible arm 18 is a suction-type connection mechanism 20 that includes a suction cup component 22 that is designed to be removably attached to a smooth surface, such as the windshield of a conventional vehicle. As will presently be described, connector mechanism 20 includes a novel suction forming and release mechanism for forming and releasing suction developed by suction cup 22.

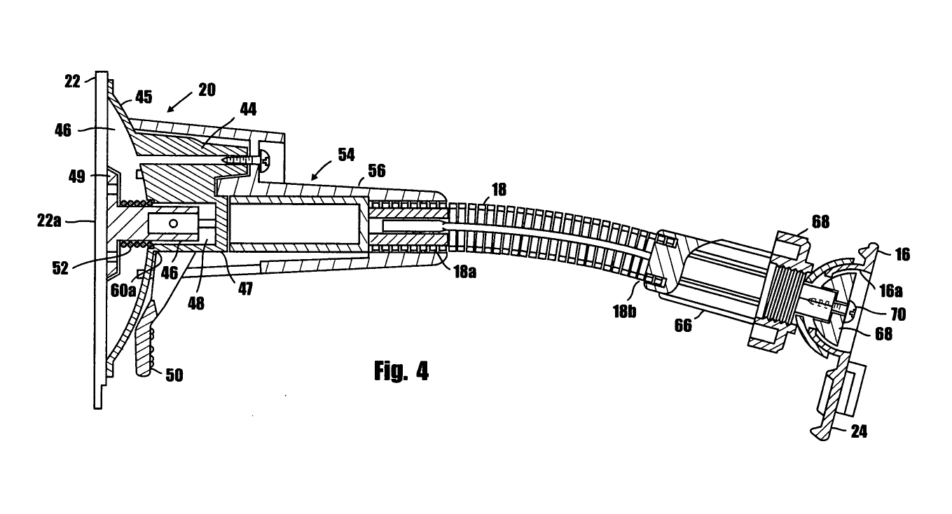

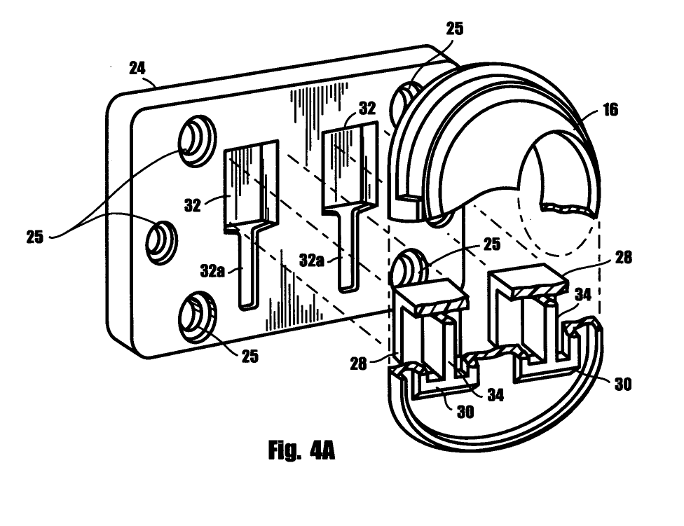

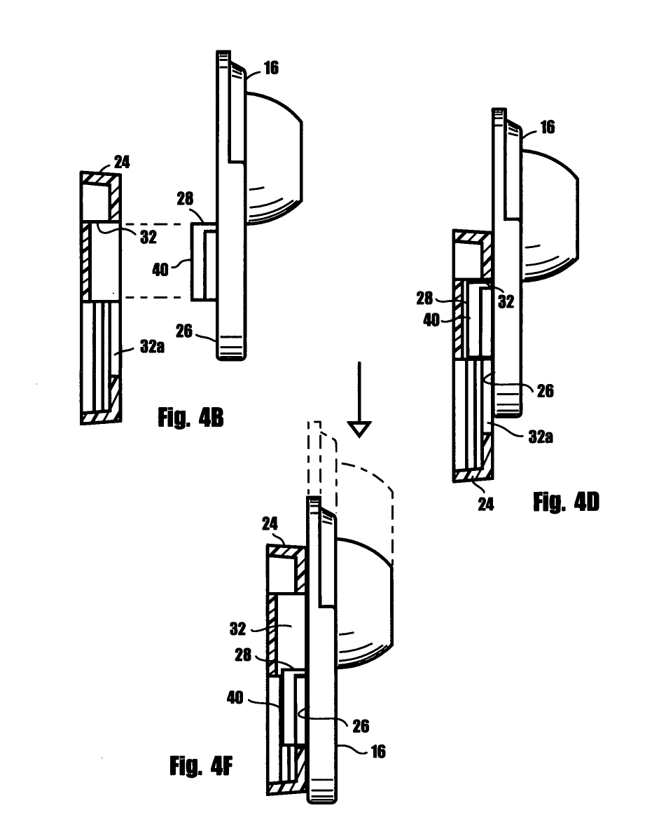

Considering now the construction of the improved mounting plate 16 and its interaction with the object connector plate 24 of the invention, as illustrated in FIGS. 1, 4A, 4B, 4C, 4D, 4E and 4F, mounting plate 16 is provided with a generally planar upper surface 26 to which a pair of uniquely configured, spaced-apart connector elements 28 are connected. As shown in FIG. 4A, each of the connector elements 28 is provided with an upstanding, generally “T”-shaped connector segment 30. “T”-shaped connector segments 30 are lockably received within spaced-apart cavities 32 formed in the article connector plate 24. Plate 24, which is illustrated in FIG. 4A, is provided with a plurality of spaced-apart apertures 25 to permit the connector plate to be interconnected with various types of cradles (not shown) for supporting articles such as, for example, cell phones, PDA's, handheld computers and like devices.

During the step of interconnecting the object connector plate 24 with the mounting plate 16, the connector plate 24 is first moved from the position shown in FIGS. 4A and 4B into the position shown in FIGS. 4C and 4D wherein the connector elements 28 of the mounting plate are moved into the upper portions the cavities 32 of the article connector plate. This done, the mounting plate is moved from the configuration shown in the dotted lines in FIGS. 4E and 4F into the position shown by the solid lines in FIGS. 4E and 4F. During this movement, the leg portions 34 of the “T”-shaped locking segments of the mounting plate will slide into the elongated slot portions 32a of the cavities 32 formed in the connector plate 24 and will be securely locked in position by the top wall portions 40 of the connector elements 30 (see FIGS. 1 and 4B). With the novel construction thus described, the uniquely designed connector elements 28 of the connector plate are snugly received within the mating cavities of the object connector plate 24 so that play between the object connector plate and the improved mounting plate is minimized. Additionally, the spaced-apart connector elements positively resist any rotational movement between the object connector plate and the mounting plate. It is these important features that are lacking in the single connector element construction of the prior art devices as exemplified by the device illustrated in FIG. 1A of the drawings.

Consider next the suction forming and release mechanism of the improved mounting structure of the present invention. Typically, in the prior art devices, suction is formed between the windshield and the suction cup portion of the suction forming mechanism by, in some way, pulling the center of the suction cup away from the windshield. When the central portion 22a of the outer surface of the suction cup body is pulled away from the windshield surface, a partial vacuum is formed causing the suction cup to adhere to the surface. The greater the vacuum, the better the suction cup adheres to the windshield surface.

As previously mentioned, the apparatus of the present invention includes a suction cup 22 that is carried by an inner housing 44 (FIG. 4) having a flange portion 45. Housing 44 is provided with concave cavity 46 and an upstanding central portion 47 having an axial passageway 48 within which a drive member 48 reciprocates (FIG. 4). When a vacuum is formed by the suction forming mechanism of the invention, the central portion of suction cup 22 is received within concave cavity 46 of the inner housing. Drive member 48 is interconnected with central portion of the suction cup by a connector flange 49 in the manner shown in FIGS. 3 and 4 and is movable by a pivotally mounted lever member 50 against the urging of a biasing means from a first retracted position to the second extended position shown in FIG. 4. This biasing means is here provided in the form of a coil spring 52 which encircles drive member 46. As illustrated in FIGS. 3 and 4 of the drawings, inner housing 44 is encased within an outer housing 54 and is held in position with respect to the outer housing by a screw 55. As illustrated in FIG. 4 of the drawings, outer housing 54 is provided with a neck portion 56 that receives the lower end of flexible neck 18.

As best seen in FIG. 3, lever member 50, which is generally yoke-shaped, has a finger engaging portion 58 and a pair of spaced-apart outwardly extending arms 60, each of which includes a cam-like extremity 60a that bears against flange 45 of the inner housing 44. Arms 60 are apertured to receive a transversely extending connector pin 62, which extends through slots 47a formed in inner housing 47 and functions to interconnect lever member 50 with the drive member 46. With this construction, when the lever member is moved pivotally upwardly from the position shown in FIG. 4, the drive member 46 along with the central portion of the suction cup 22 will also move upwardly causing a suction to be formed which will hold the supporting structure securely in position on the vehicle windshield.

When it is desired to remove the supporting structure from the vehicle windshield and to break the vacuum holding it in position, a pressure exerted against the finger engaging portion 58 of lever member 50 against the urging of spring 52 will cause the lever member to pivot into the downward position shown in FIG. 4. This downward movement of lever member 50 will cause the cam-like extremities 60a of the arms 62 to bear against flange 45 in a manner to cause drive member 46 to move downwardly as shown in FIG. 4, thereby releasing the vacuum formed within the vacuum cup 22.

The uniquely constructed and easy and convenient to operate suction forming and release mechanism of the improved mounting structure of the present invention as described in the preceding paragraphs comprises a substantial improvement over the prior art suction forming and release mechanism provided on the prior art device illustrated in FIG. 1A of the drawings. More particularly, as indicated in FIG. 1A, in the prior art device there illustrated, suction forming and release is accomplished by a turn-wheel type mechanism which requires the awkward and cumbersome rotation of a rotatable, wheel-like member “W” provided near the base of the prior art device.

Another improvement of the supporting structure of the present invention over the prior art device illustrated in FIG. 1A, resides in the previously identified connector means which interconnects the mounting plate 16 with the elongated flexible arm 18. As indicated in FIG. 1A, the mounting head “MH” of the prior art device is interconnected with the elongated flexible arm by means of a compression joint that is tightened and loosened by a thumbscrew “TM”. Unlike the novel ball and socket connector means of the present invention which permits a swiveling movement of the connector plate relative to the flexible arm, the connector plate of the prior art device can only be moved along a fixed arc as a portion of the compression joint is rotated.

As best seen by referring to FIGS. 3 and 4 of the drawings, mounting plate 16 of the present invention includes a hemispherical-shaped, ball-like portion 16a which is receivable in a socket-like portion 64 that is carried by an externally threaded connector head 66 to which the flexible neck 18 is interconnected. More particularly, threaded connector head 66 includes an outwardly extending shank portion 66a which is received within a square aperture 64a formed in socket-like portion 64. A generally hemispherical-shaped spacer 68, which is interconnected with shank portion 66 by means of a screw 70 is closely received within ball-like portion 16a of mounting plate 16 in the manner illustrated in FIG. 4. An internally threaded connector ring 68 is threadably connected to connector head 66 to hold the various components of the connector means in the assembled configuration illustrated in FIG. 4 of the drawings. With the novel construction thus described, mounting plate 16 along with the article connector plate can be controllably revolved in a manner to position the plates within a plane that permits optimum viewing and operation of the particular object that is interconnected with the object connector plate. This unique positioning of the object connector plate 24 and the device supported thereby is not possible with prior art devices such as those exemplified in FIG. 1A of the drawings.

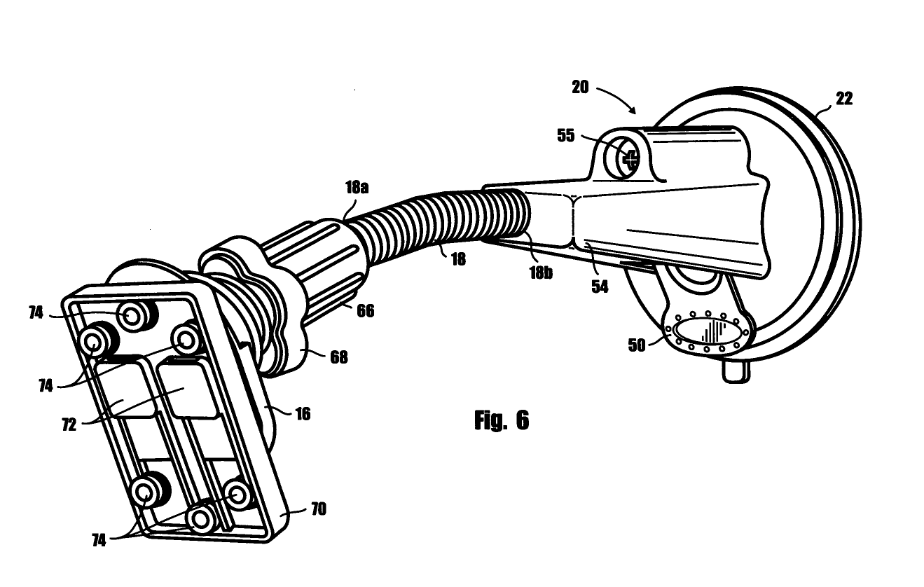

Turning to FIG. 6, an alternate form of object connector plate 70 is shown interconnected with the mounting structure of the character previously described. Object connector plate 70 is similar in construction to object connector plate 24, but is uniquely provided with connector cavities 72 that extend lengthwise of the plate rather than transversely. This construction permits differently configured devices to be interconnected with the object connector plate using the connector apertures 74.

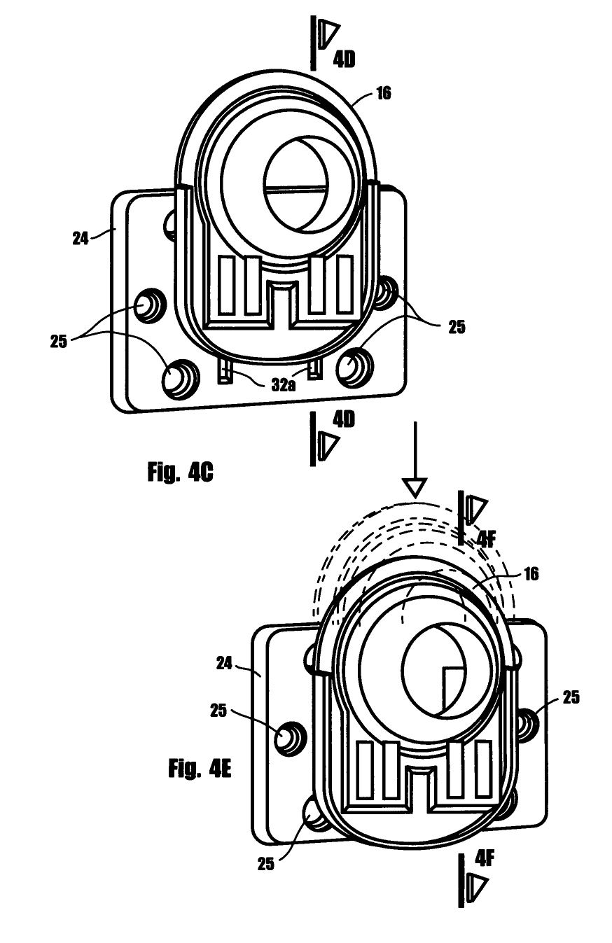

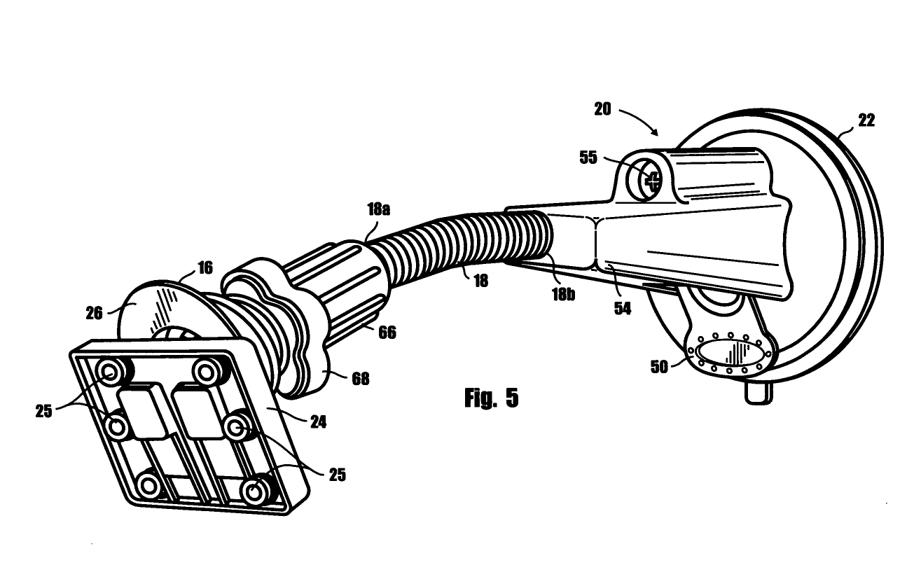

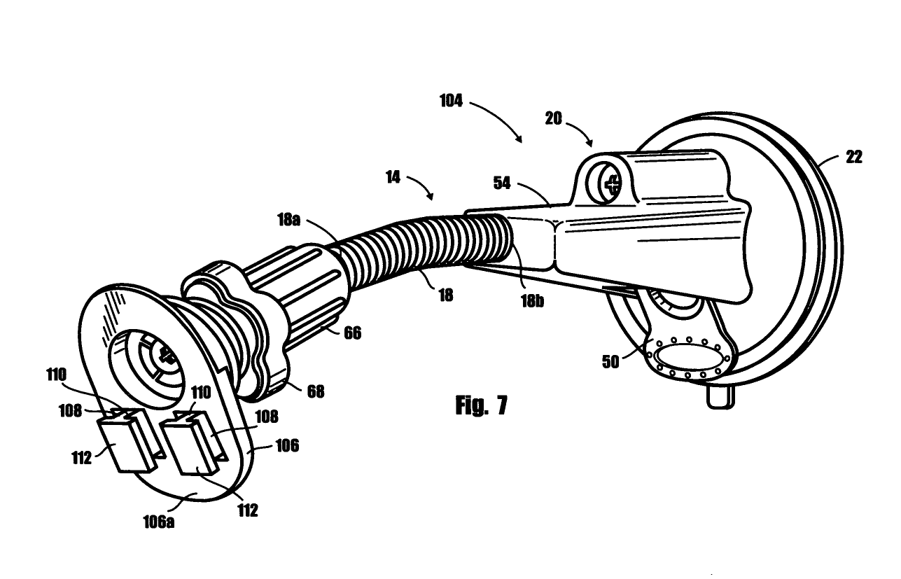

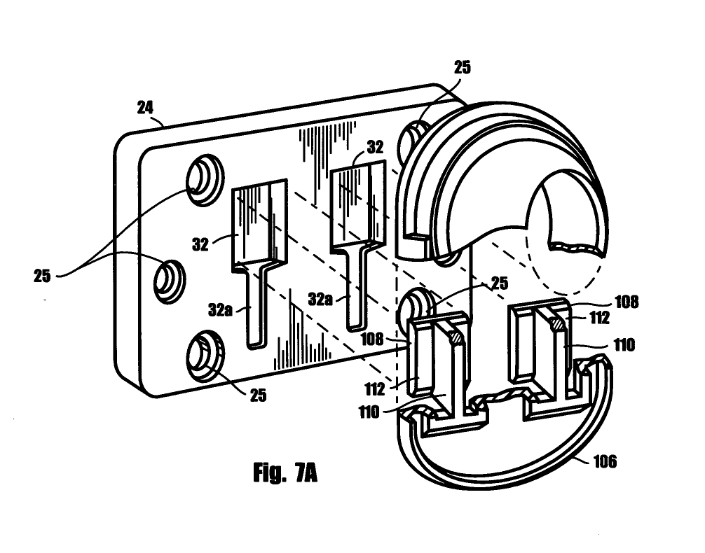

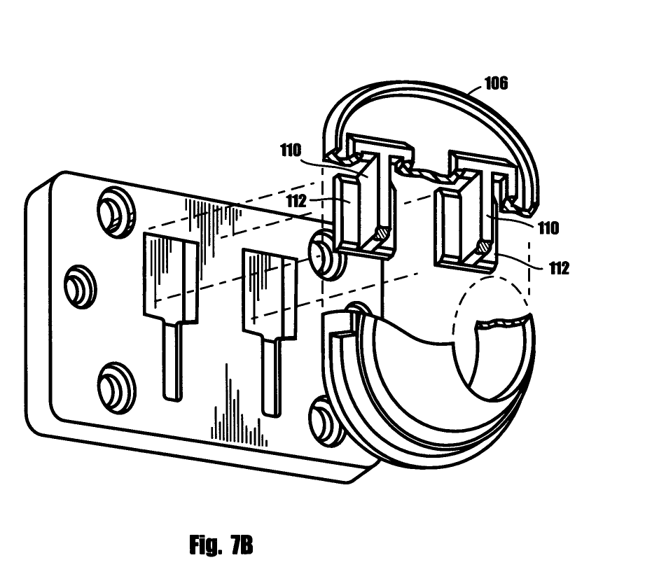

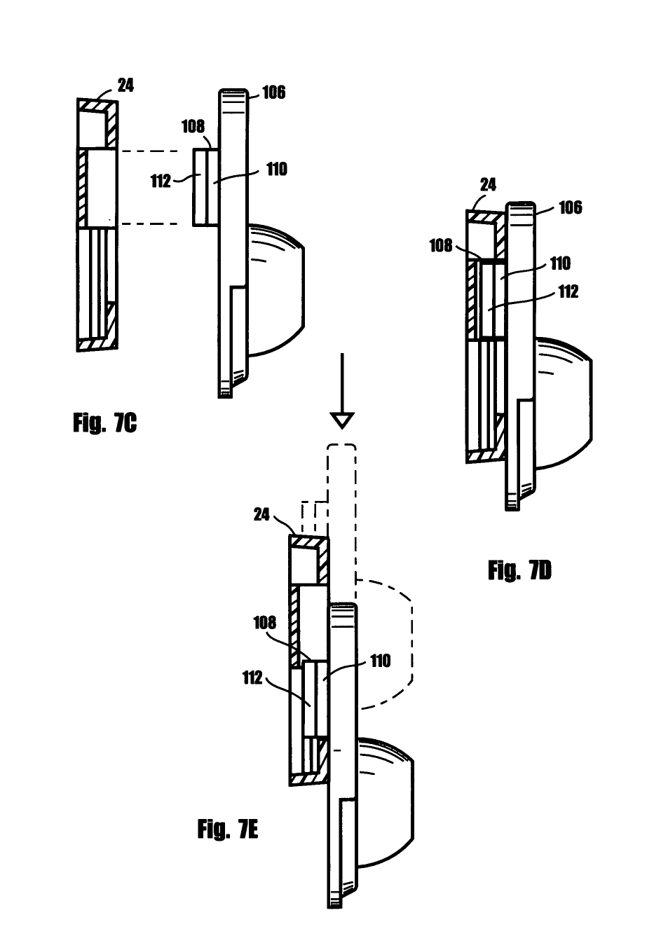

Referring now to FIGS. 7, 7A and 7B, another form of the improved mounting structure of the present invention for use with a selected object connector plate is there illustrated and generally designated by the numeral 104. This embodiment of the invention is similar in many respects to that illustrated in FIGS. 1 through 6 and described in the preceding paragraphs. Accordingly like numerals are used in FIGS. 7, 7A and 7B to identify like components. The primary difference between this latest embodiment of the invention and the earlier described inventions resides in the differently constructed mounting plate 106 of the invention to which a selected object connector plate can be interconnected to form the object mounting structure of the invention. As will be described in greater detail in the paragraphs that follow, because of its configuration, the mounting plate 16 of the earlier described embodiment could be interconnected with the object connector plate in only one direction. However, the novel mounting plate 106 of this latest form of the invention can advantageously be interconnected with the object connector plate in two directions. With this unique construction the object that is interconnected with the connector plate can initially be located in a first position within the vehicle and, if desired, can also be located in an inverted position.

As shown in FIG. 7 of the drawings, the differently configured mounting plate 106 is interconnected with the first end 18a of an elongated flexible arm 18 by connector means that is substantially identical to the connector means described in connection with the embodiment of FIGS. 1 through 6. Connected at the opposite, or second, end 18b of flexible arm 18 is a suction-type connection mechanism 20 that includes a suction cup component 22 that is designed to be removably attached to a smooth surface, such as the windshield of a conventional vehicle. As before, connector mechanism 20 includes a substantially identical suction forming and release mechanism for forming and releasing suction developed by suction cup 22.

Considering now the details of the construction of the improved mounting plate 106 and its interaction with the object connector plate of the invention, mounting plate 106 is provided with a generally planar upper surface 106a to which a pair of uniquely configured, spaced-apart connector elements 108 are connected (see FIGS. 7 and 7A). Uniquely, each of the open ended connector elements 108 is provided with an upstanding, generally vertical member 110 and a general horizontal flange 112 that is connected to vertical member 110. Open-ended connector elements 108, which as shown in FIG. 7A of the drawings, are generally T-shaped in cross-section and are lockably received within spaced-apart cavities formed in the article connector plate 24. Plate 24, which is of substantially identical construction and operation to that previously described in connection with the embodiment of FIG. 4A, is provided with a plurality of spaced-apart apertures 25 to permit the connector plate to be interconnected with various types of cradles (not shown) for supporting articles such as, for example, cell phones, PDA's, handheld computers and like devices.

During the step of interconnecting the object connector plate 24 with the mounting plate 106, the connector plate is moved, in the manner previously described, from the position shown in FIGS. 7B and 7C into the locked position wherein the open-ended connector elements 108 of the mounting plate are moved into the upper portions of the cavities 32 of the article connector plate. More particularly, as illustrated in FIGS. 7C, 7D and 7E, the mounting plate is moved from the position shown in FIG. 7C into the position shown in FIG. 7D and then into the locked position shown in FIG. 7E. With the novel construction thus described, the uniquely designed connector elements 108 of the connector plate are snugly received within the mating cavities of the object connector plate 24 so that play between the object connector plate and the improved mounting plate is minimized. Additionally, the spaced-apart connector elements positively resist any rotational movement between the object connector plate and the mounting plate.

As previously discussed, because of the novel construction of the open-ended connector elements of the mounting plate, the mounting plate can be inverted in the manner illustrated in FIG. 7B and then interconnected with the object connector plate of the invention in the manner previously described and illustrated in FIGS. 7C, 7D and 7E.

With the mounting plate connected to the connector plate, either in the position shown in FIG. 7A of the drawings, or in the inverted position shown in FIG. 7B, by using the suction cup mechanism, the assemblage can be connected to the vehicle windshield in the manner previously described.

When it is desired to remove the assemblage from the vehicle windshield and to break the vacuum holding it in position, a pressure exerted against the finger engaging portion 58 of lever member 50 against the urging of spring 52 will cause the lever member to pivot into a downward position shown. This downward movement of lever member 50 will cause the cam-like extremities 60a of the arms 62 to bear against flange 45 in a manner to cause drive member 46 to move downwardly as shown in FIG. 4, thereby releasing the vacuum formed within the vacuum cup 22.

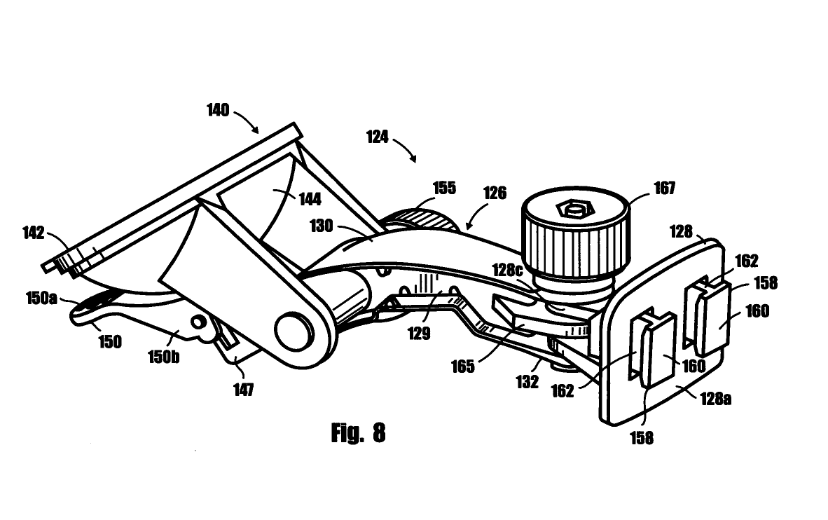

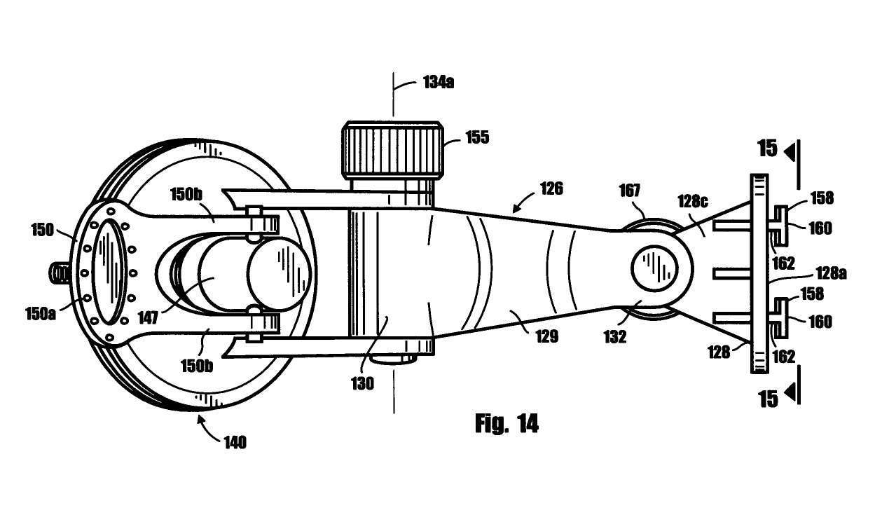

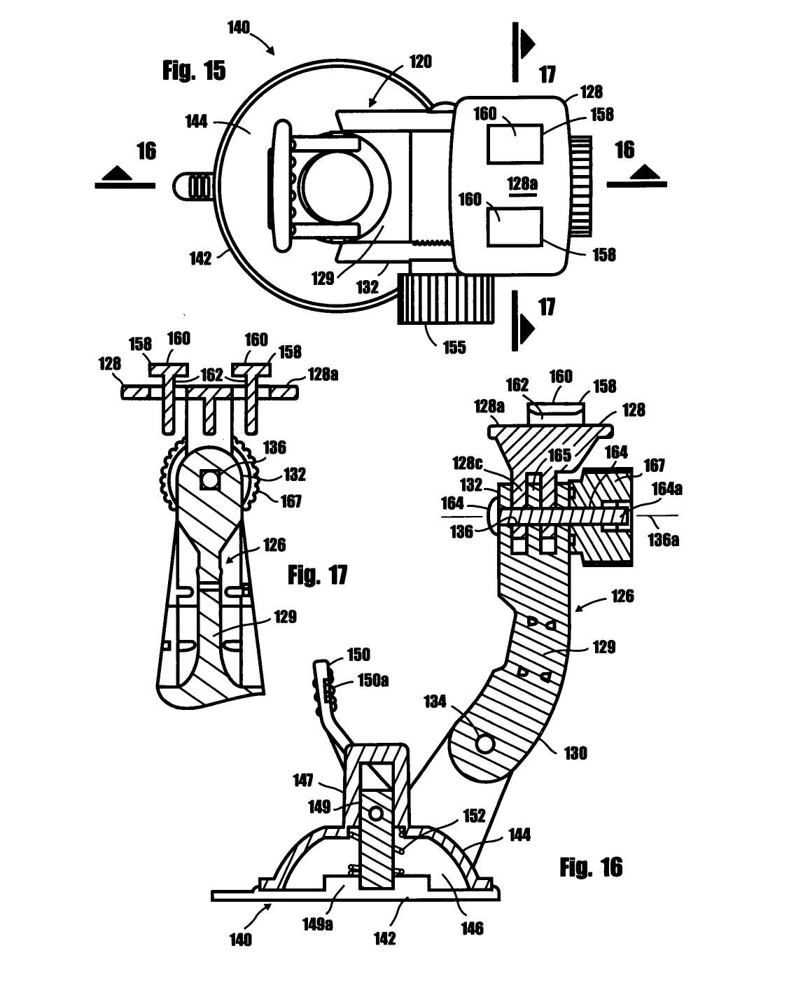

Turning now to FIGS. 8 through 19B of the drawings, still another form of the improved mounting structure of the invention for supporting objects within a vehicle is there shown and generally designated by the numeral 124. This embodiment of the invention is similar in some respects to the embodiments illustrated in FIGS. 1 through 7E and like numerals are used in FIGS. 8 through 19B to identify like components. The primary difference between this latest embodiment of the invention and the earlier described invention resides in the differently constructed connector arm assembly 126 that supports the mounting plate 128. As will be discussed in greater detail in the paragraphs that follow, the mounting plate 128 to which a selected object connector plate 24 is interconnected is similar in construction and operation to mounting plate 106 and can be connected to the object connector plate in two directions.

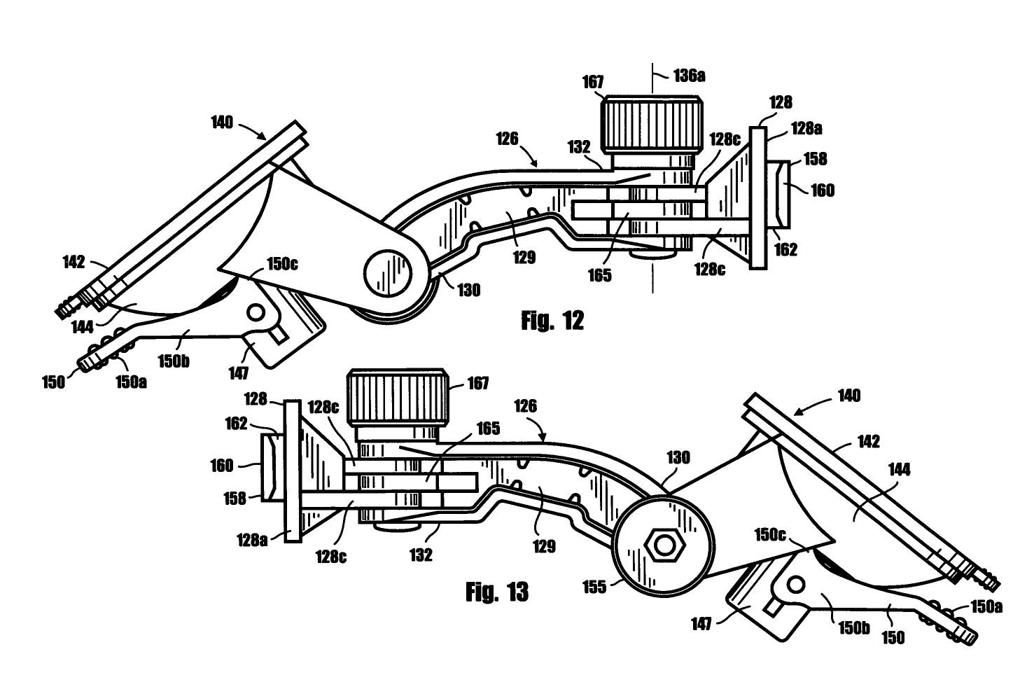

As best seen in FIGS. 12, 13 and 14, connector assembly 126 here comprises a rigid, elongated, curved connector arm 129 having a first end 130 and a second end 132. First end 130 of the connector arm has a first bore 134 there through (FIG. 17) that has a first axis 134a (see also FIG. 14). Second end 132 of the connector arm, which is of a generally yoke shaped configuration (FIG. 12), has a second bore 136 there through (FIG. 17). Second bore 136 has a second axis 136a (see also FIG. 12).

As in the embodiment of FIGS. 1 through 6, this latest form of the invention also includes a suction forming and release mechanism 140 that is similar in construction and operation to the previously described section forming and release mechanism 20. Mechanism 140 includes a suction cup 142 that is carried by a housing 144 (FIG. 17) having a flange portion 145. Housing 144 is provided with concave cavity 146 and an upstanding central portion 147 having an axial passageway within which a drive member 149 reciprocates. When a vacuum is formed by the suction forming mechanism of the invention, the central portion of suction cup 142 is received within concave cavity 146.

As in the earlier described embodiments of the invention, drive member 149 is interconnected with central portion of the suction cup by a connector flange 149a and is movable by a pivotally mounted lever member 150 against the urging of a biasing means from a first retracted position to the second extended position. This biasing means is here provided in the form of a coil spring 152 which encircles drive member 149 (FIG. 17). As best seen in FIG. 3, lever member 150, which is generally yoke-shaped, has a finger engaging portion 150a and a pair of spaced-apart outwardly extending arms 150b, each of which includes a cam-like extremity 150c that bears against housing 144. With this construction, when the lever member is moved pivotally upwardly, the drive member 149 along with the central portion of the suction cup 142 will also move upwardly causing a suction to be formed which will hold the supporting structure securely in position on the vehicle windshield.

When it is desired to remove the supporting structure from the vehicle windshield and to break the vacuum holding it in position, a pressure exerted against the finger engaging portion 150a of lever member 150 against the urging of spring 152 will cause the lever member to pivot into the downward position. This downward movement of lever member 50 will cause the cam-like extremities of the arms 150b to bear against the housing 144 in a manner to cause drive member 149 to move downwardly, thereby releasing the vacuum formed within the vacuum cup 142.

For a reason presently to be described, suction forming mechanism 140 is rotatable about first axis 134a. As best seen in FIG. 17, housing 144 of the suction forming mechanism 140 here includes a generally yoke shaped connector portion 144a that is closely receivable over the first end 130 of the elongated connector arm 129. Another novel feature of this latest form of the invention comprises means for preventing rotation of the suction cup forming mechanism relative to the first end of the elongated connector arm.

Suction forming mechanism 140 is rotatably interconnected with the first end 130 of the connector arm 126 by an elongated, threaded bolt 154 that extends through openings 144b formed in the yoke 144a of housing 144 and a through bore 134 formed in the first end of the connector arm. An internally threaded tightening knob 155 is connected to the threaded end 154a of bolt 154 and when tightened down against the first end of the connector arm prevents rotation of the suction forming mechanism 140 relative to the first end of the connector arm. In this latest form of the invention both threaded bolt 154 in cooperating tightening knob 155 comprise a part of the means for preventing rotation of the suction cup forming mechanism relative to the first end of the elongated connector arm.

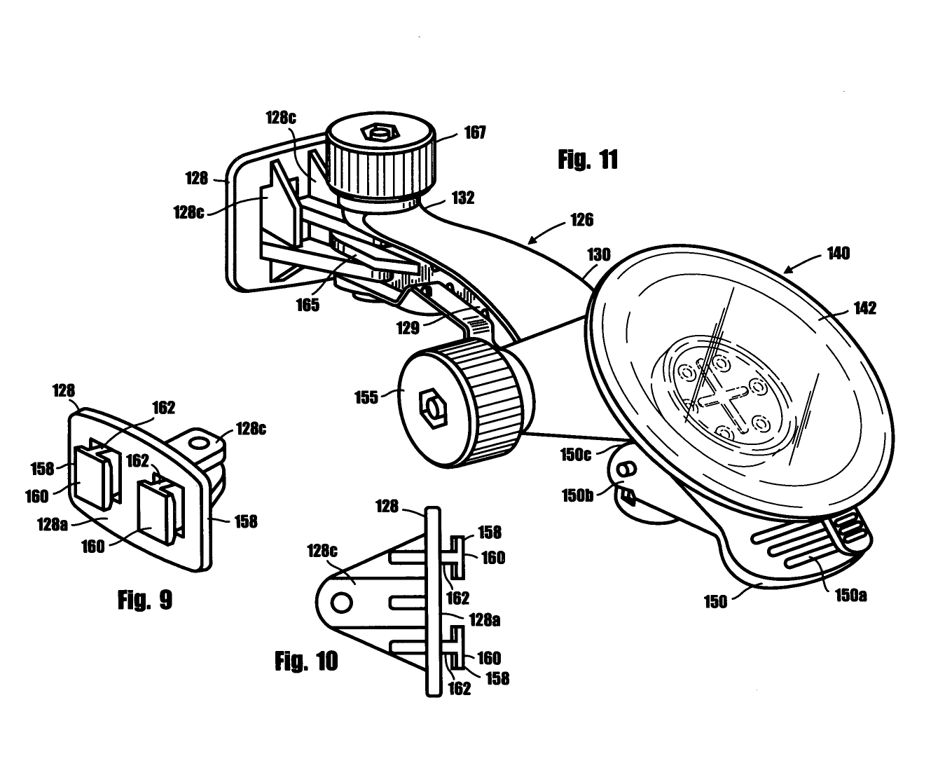

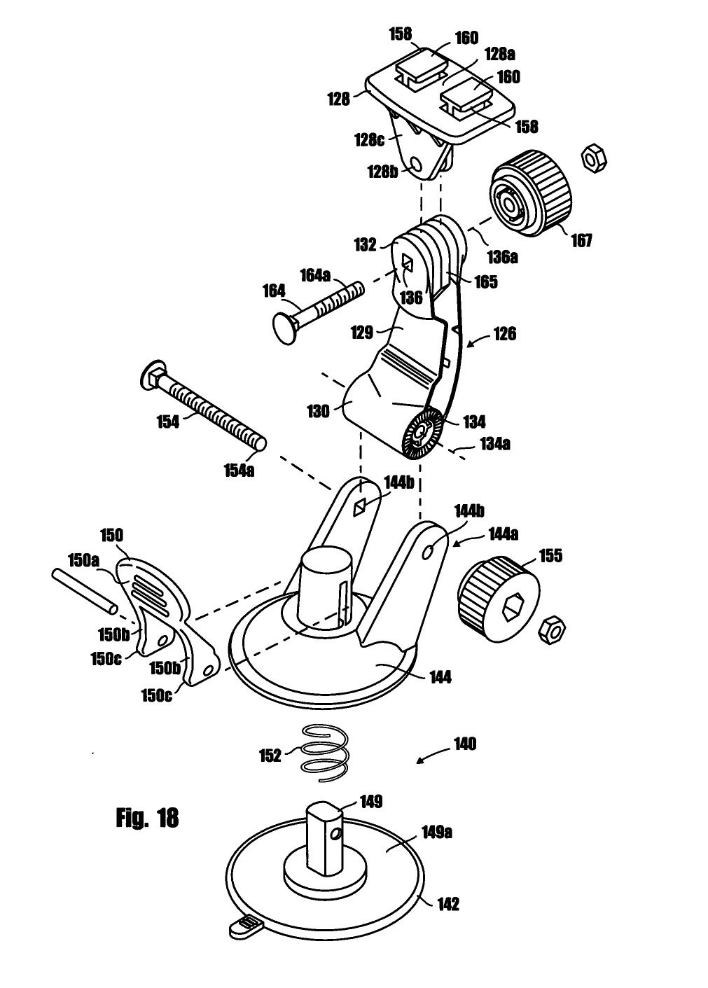

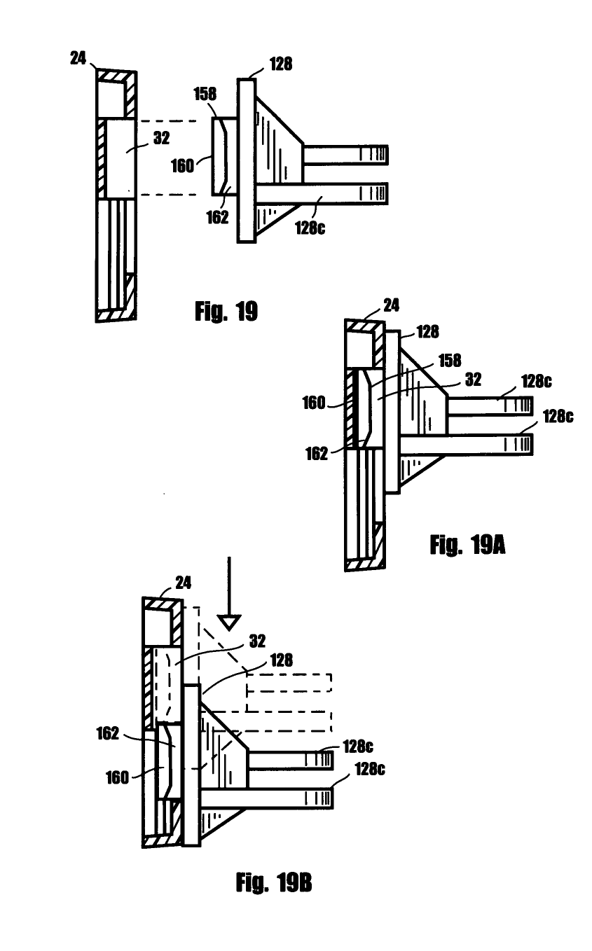

Connected to the second, yoke shaped end 132 of the connector arm for rotation about second axis 136a of second bore 136 is the mounting plate 128 that includes a generally planar surface 128a and a pair of transversely spaced-apart connector elements 158 that extend there from (FIG. 9). Each of the pair of spaced-apart, open ended connector elements are of substantially the same construction as connector elements 108 and include a general horizontal flange 160 that is connected to a vertical member 162. Open-ended connector elements 158, which are generally T-shaped in cross-section, are lockably received within spaced-apart cavities 32 formed in the article connector plate 24 (see FIGS. 19, 19A and 19B). Plate 24, which is of substantially identical construction and operation to that previously described in connection with the embodiment of FIG. 4A, is provided with a plurality of spaced-apart apertures to permit the connector plate to be interconnected with various types of cradles (not shown) for supporting articles such as, for example, cell phones, PDA's, handheld computers and like devices.

In a manner presently to be described, mounting plate 128 is rotatably interconnected with the second end 132 of the connector arm 126. Another novel feature of this latest form of the invention comprises means for preventing rotation of the mounting plate 128 relative to the first end of the elongated connector arm. This novel means here comprises an elongated, threaded bolt 164 that extends through openings 128b formed in a yoke 128c of mounting plate 128, through a central wall 165 that forms a part of the yoke shaped second end 132 of the connector a and through bore 136 formed in the second end of the connector arm. As best seen in FIG. 12 of the drawings, yoke 128c of the mounting plate is received within the yoke shaped second end 132 of the connector arm. Yoke 128cc of the mounting plate, in turn, closely receives the central wall 165 that forms a part of the yoke shaped second end 132 of the connector arm. Further comprising a part of the means for preventing rotation of the mounting plate 128 relative to the first end of the elongated connector arm is an internally threaded tightening knob 167 that is connected to the threaded end 164a of bolt 164 (FIGS. 16 and 17). When tightened down against the first end of the connector arm, tightening knob 167 prevents rotation of the mounting plate 128 relative to the second end of the connector arm.

Referring now to FIGS. 19, 19A and 19B, during the step of interconnecting the object connector plate 24 with the mounting plate 128, the connector plate is moved from the position shown in FIG. 19 into the position shown in FIG. 19A wherein the open-ended connector elements 158 of the mounting plate are moved into the upper portions of the cavities 32 of the article connector plate. Next, the mounting plate is moved, from the position shown in FIG. 18A into the locked position shown in FIG. 19B. With the novel construction thus described, the uniquely designed connector elements 158 of the connector plate are snugly received within the mating cavities of the object connector plate 24 so that play between the object connector plate and the improved mounting plate is minimized. Additionally, the spaced-apart connector elements positively resist any rotational movement between the object connector plate and the mounting plate.

As previously discussed, because of the novel construction of the open-ended connector elements 128, the mounting plate can be interconnected with the object connector plate in a first upright position or alternatively, if desired in and inverted position.

With the mounting plate connected to the connector plate, either in the upright position, or in the inverted position, by using the suction cup mechanism, the assemblage can be connected to the vehicle windshield in the manner previously described. By loosening tightening knob 167, the mounting plate, along with the object connected to the object connector plate can be rotated about axis 136a to any desired position. Similarly, by loosening tightening knob 167, the connector arm assembly, along with the object connected to the object connector plate can be rotated about axis 136a to any desired position.

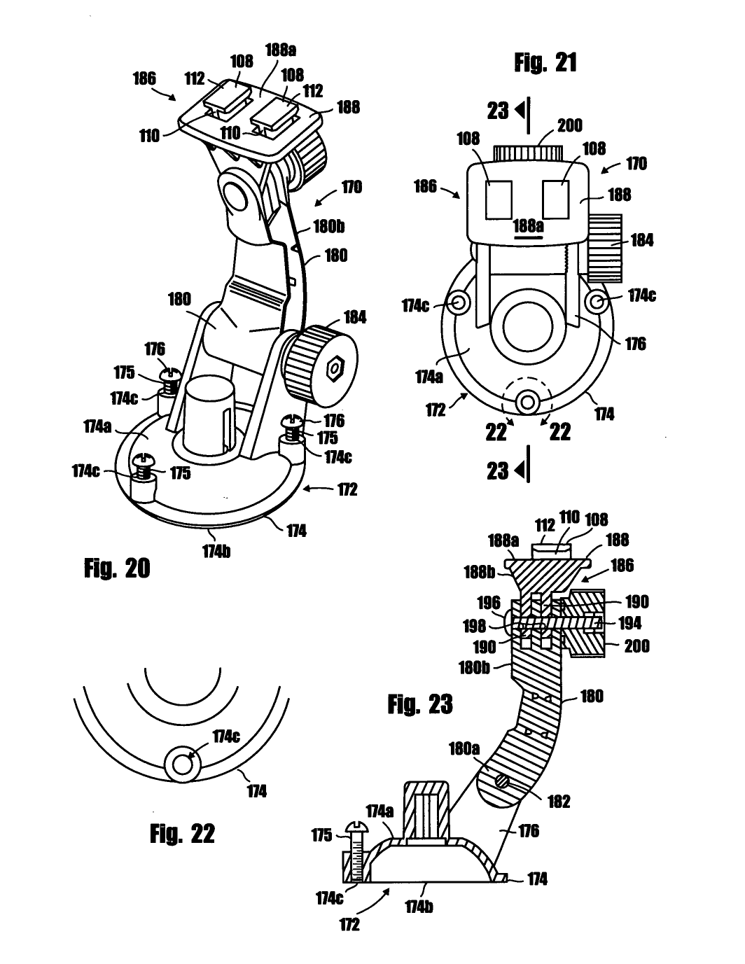

Referring to FIGS. 20 and 21, an alternate form of the improved mounting structure of the present invention is there illustrated and generally designated by the numeral 170. Embodiment 170 is similar in some respects to the earlier described embodiments and like numerals are used in FIGS. 21 through 23 to identify like components. One of the primary differences between this latest form of the invention and the earlier described embodiments resides in the provision of a differently constructed connection mechanism 172. As best seen in FIGS. 20 and 21, connection mechanism 172 rather than being a suction type mechanism, comprises a generally circular shaped connector plate 174 having an upper surface 174a having a central portion and a lower surface 174b provided with a plurality of circumferentially spaced apart apertures 174c that are adapted to receive a plurality circumferentially spaced threaded connectors such as connector screws or bolts 175 that can be used to interconnect the connector plate 172 with a generally planar surface of a structural member of the vehicle, such as, for example, the vehicle dashboard.

As illustrated in FIGS. 20 and 23, the connector plate 174 is interconnected to a pair of spaced apart, upstanding connector legs 176 that are, in turn, connected to the first, or lower, end 180a of elongated connector arm 180. Lower end 180a of the connector arm is closely received between connector legs 176 and is pivotally movable relative thereto about a shaft 182 (FIG. 23) that extends through a transverse bore provided in lower end 180a of connector arm 180. Shaft 182 is provided with a threaded end portion that threadably receives a knurled locking knob 184 that can be tightened relative to shaft 182 to lock connector arm 180 against rotation relative to connector legs 176.

Pivotally connected to the second, or upper, end 180b of connector arm 180 is the mounting plate assembly 186 of this latest form of the invention to which a selected object connector plate can be connected in the manner previously described herein. As best seen in FIG. 23, mounting plate assembly 186 comprises a mounting plate 188 having a generally planar upper surface 188a. Extending downwardly from the lower surface 188b of the mounting plate is a pair of mounting plate connector legs 190 (FIG. 23). Connector legs 190 are closely received within a pair of spaced apart grooves 192 formed in the upper end 180b of curved body 180. End 180b is provided with a bore 194 that is adapted to closely receive there through a threaded bolt 196. Each of the connector legs 190 is provided with a bore 198 that can be indexedly aligned with bore 194 so that the threaded bolt 196 also can also be received there through in the manner shown in FIG. 23 of the drawings. The threaded end portion of threaded bolt 196 threadably receives a second knurled locking knob 200 that can be tightened relative to bolt 196 to lock the mounting plate assembly 186 against rotation relative to the upper end 180b of connector arm 180.

As illustrated in FIGS. 20, 21 and 23 of the drawings, a pair of uniquely configured, spaced-apart connector elements 108 are connected to upper surface 188a. Connector elements 108 are of identical construction and operation to the earlier described connector elements that are illustrated in FIGS. 14, 17 and 18. More particularly, each of the open ended connector elements 108 is provided with an upstanding, generally vertical member 110 and a general horizontal flange 112 that is connected to vertical member 110. Open-ended connector elements 108 which, as shown in FIG. 20 of the drawings, are generally T-shaped in cross-section and in the manner previously described are lockably received within spaced-apart cavities formed in the article connector plate 24 (see FIG. 19) that is provided with a plurality of spaced-apart apertures 25 to permit the connector plate to be interconnected with various types of cradles (not shown) for supporting articles such as, for example, cell phones, PDA's, handheld computers and like devices.

Open-ended connector elements 108 are interconnected with the object connector plate 24 in the manner previously described and as illustrated in FIGS. 19, 19A and 19B.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

I claim:

1. A mounting structure for supporting objects within a vehicle comprising:
(a) an elongated connector arm having first and second ends;
(b) a connection mechanism connected to said first end of said elongated connector arm, said connection mechanism having an upper surface having a central portion and a lower surface for engagement with a generally planar surface; and
(c) a mounting plate connected to said second end of said elongated connector arm, said mounting plate including a generally planar surface and a pair of transversely spaced-apart open ended connector elements extending there from, each of said pair of spaced-apart open ended connector elements of said mounting plate comprising a generally vertically extending member and an elongated flange member connected to said generally vertically extending member.

2. The mounting structure as defined in claim 1, further including an object connector plate interconnected with said mounting plate, said object connector plate having a pair of spaced-apart cavities constructed and arranged to lockably receive said vertically extending members of said pair of spaced-apart connectors of said mounting plate.

3. The mounting structure as defined in claim 1, in which said connection mechanism comprises a plurality circumferentially spaced apart threaded connectors and a connector plate having a plurality circumferentially spaced apart apertures.

4. The mounting structure as defined in claim 1, in which said connection mechanism comprises a suction forming mechanism.

5. The mounting structure as defined in claim 4 in which said suction forming mechanism comprises:
(a) a housing having an axial passageway;
(b) a drive member connected to said suction cup and reciprocally movable within said axial passageway of said housing; and
(c) a finger engaging, pivotally mounted lever member connected to said drive member for reciprocally moving said drive member within said axial passageway of said inner housing from a first retracted position to the second extended position.

6. The mounting structure as defined in claim 4 in which said elongated connector arm is yieldably deformable.

7. The mounting structure as defined in claim 4 in which said elongated connector arm is rigid.

8. The mounting structure as defined in claim 4 in which said first end of said elongated connector arm has first bore there through, said first bore having a first axis and in which said suction forming mechanism is rotatable about said first axis.

9. The mounting structure as defined in claim 8 in which said second end of said elongated connector arm has a second bore there through, said second bore having a second axis and in which said mounting plate is rotatable about said second axis.

10. A mounting structure for supporting objects within a vehicle comprising:
(a) an elongated connector arm, including a first end having a first bore there through, said first bore having a first axis and a second, yoke shaped end having a second bore there through, said second bore having a second axis;
(b) a suction forming mechanism connected to said first end of said elongated connector arm for rotation about said first axis, said suction forming mechanism including a suction cup having an inner surface having a central portion and an outer surface for engagement with a smooth surface; and
(c) a mounting plate connected to said second, yoke shaped end of said elongated connector arm for rotation about said axis of said second bore, said mounting plate including a generally planar surface and a pair of transversely spaced-apart open ended connector elements extending there from, each of said pair of spaced-apart open ended connector elements of said mounting plate comprising a generally vertically extending member and an elongated flange member connected to said generally vertically extending member.

11. The mounting structure as defined in claim 10, further including an object connector plate interconnected with said mounting plate, said object connector plate having a pair of spaced-apart cavities constructed and arranged to lockably receive said vertically extending members of said pair of spaced-apart connectors of said mounting plate.

12. The mounting structure as defined in claim 10 in which said suction forming mechanism comprises:
(a) a housing having an axial passageway;
(b) a drive member connected to said suction cup and reciprocally movable within said axial passageway of said housing; and
(c) a finger engaging, pivotally mounted lever member connected to said drive member for reciprocally moving said drive member within said axial passageway of said inner housing from a first retracted position to the second extended position.

13. A mounting structure for supporting objects within a vehicle comprising:
(a) an elongated substantially rigid connector arm, including a first generally yoke shaped end having a first bore there through, said first bore having a first axis and a second, yoke shaped end having a second bore there through, said second bore having a second axis;
(b) a suction forming mechanism connected to said first end of said elongated connector arm for rotation about said first axis, said suction forming mechanism including a suction cup having an inner surface having a central portion and an outer surface for engagement with a smooth surface;
(c) a mounting plate connected to said second, yoke shaped end of said elongated connector arm for rotation about said axis of said second bore, said mounting plate including a generally planar surface and a pair of transversely spaced-apart open ended connector elements extending there from, each of said pair of spaced-apart open ended connector elements of said mounting plate comprising a generally vertically extending member and an elongated flange member connected to said generally vertically extending member; and
(d) an object connector plate interconnected with said mounting plate, said object connector plate having a pair of spaced-apart cavities constructed and arranged to lockably receive said vertically extending members of said pair of spaced-apart connectors of said mounting plate.

14. The mounting structure as defined in claim 13 in which said suction forming mechanism comprises:
(a) a housing having an axial passageway;
(b) a drive member connected to said suction cup and reciprocally movable within said axial passageway of said housing; and
(c) a finger engaging, pivotally mounted lever member connected to said drive member for reciprocally moving said drive member within said axial passageway of said inner housing from a first retracted position to the second extended position.

15. The mounting structure as defined in claim 14 further including means for preventing rotation of said suction cup forming mechanism relative to said first end of said elongated connector arm, said means comprising a first elongated, threaded bolt extending through said first bore in said first end of said elongated connector arm and a first internally threaded tightening knob connected to said threaded bolt.

16. The mounting structure as defined in claim 15, further including means for preventing rotation of said mounting plate relative to said second end of said elongated connector arm, said means comprising a second elongated, threaded bolt extending through said second bore in said second end of said elongated connector arm and a second internally threaded tightening knob connected to said second threaded bolt.
